(19) United States
(12) Patent Application Publication
(10) Pub. No.: US 2014/0151516 A1
(43) Pub. Date: Jun. 5, 2014

(54) Speaker Stand Capable of Changing an Angle and a Position of a Speaker

(71) Applicant: Li-Hsing Liu, Luzhu Township (TW)

(72) Inventor: Li-Hsing Liu, Luzhu Township (TW)

(21) Appl. No.: 13/705,397

(22) Filed: Dec. 5, 2012

(51) Int. Cl. H04R 1/02

(52) U.S. Cl. CPC H04R 1/026
USPC 248/124.1

(57) ABSTRACT

A speaker stand of a speaker is used to support a speaker and contains: a base, an upright tube, an adjustable tube, a securing set, a connecting rod, a fixing member, a rotating member, and a positioning plate. The base includes an upright tube disposed therein. The adjustable tube is mounted in and moves upwardly and downwardly in the base. The securing set, is fitted on a top end of the adjustable tube, rotates 360 degrees leftward and rightward relative to the upright tube, and moves upwardly and downwardly. A fixing member is located at one end of the connecting rod. The rotating member is axially connected with and rotates relative to the fixing member, and a positioning plate is secured on one side of the rotating member and rotates along the rotating member.

### BACKGROUND OF THE INVENTION

1. Field of the Invention

The present invention relates to a speaker stand, and more particularly to a speaker stand capable of changing an angle and a position of a speaker which allows adjusting its angle and positioning a speaker's position stably.

2. Description of the Prior Art

A conventional sound set contains a host and a plurality of speakers, the host matches with the plurality of speakers to amplify sounds and to play music well. However, because the plurality of speakers are fixed at different positions indoors so as to obtain a preferable sound field, a professional speaker stand for fixing a respective speaker is not provided (because the plurality of speakers are fixed randomly or are fixed by an easy stand without being adjusted). If in a limited indoor space, the plurality of speakers have to be fixed obliquely, yet such an easy stand can not be used to adjust the respective speaker obliquely. In addition, the conventional stand is fixed without being adjusted toward an optimal sound field according to requirement, thus causing inconvenience.

Moreover, the respective speaker is adjusted toward a desired height and a desired angle by moving it manually, thus adjusting the respective speaker inconveniently.

The present invention has arisen to mitigate and/or obviate the afore-described disadvantages.

### SUMMARY OF THE INVENTION

The primary object of the present invention is to provide a speaker stand capable of changing an angle and a position of a speaker which allows adjusting its angle and positioning the speaker's position stably.

Secondary object of the present invention is to provide a speaker stand capable of changing an angle and a position of a speaker which allows adjusting speaker's tilted angle and position.

Further object of the present invention is to provide a speaker stand capable of changing an angle and a position of a speaker which allows placing the speaker at the desired position indoors randomly based on an indoor space and appearance so as to obtain using convenience

Another object of the present invention is to provide a speaker stand capable of changing an angle and a position of a speaker which is simplified and is operated easily to adjust the speaker toward a desired position.

A speaker stand capable of changing an angle and a position of a speaker is used to support a speaker and contains: a base, an upright tube, an adjustable tube, a securing set, a connecting rod, a fixing member, a rotating member, and a positioning plate. The base includes an upright tube disposed therein. The adjustable tube is mounted in and moves upwardly and downwardly in the base.

The securing set, is fitted on a top end of the adjustable tube, moves vertically and rotates 360 degrees leftward and rightward relative to the upright tube by ways of the adjustable tube. The connecting rod is connected with the securing set and moves leftward and rightward relative to the securing set, a fixing member is located at one end of the connecting rod. The rotating member is axially connected with and rotates relative to the fixing member, and a positioning plate is secured on one side of the rotating member and rotates along the rotating member. The adjustable tube includes a plurality of pores defined thereon, and the upright tube includes at least one first locating element for being inserted into one of the plurality of pores so as to fix the adjustable tube.

Preferably, the securing set includes a covering member, and the covering member has a through hole formed thereon so that the connecting rod inserts into and horizontally moves in the through hole. The covering member is fitted on the top end of the adjustable tube and moves vertically and rotates 360 degrees leftward and rightward around the adjustable tube. The covering member also has at least one second locating element disposed thereon so as to fix the connecting rod on the covering member. In addition, the covering member further has at least one third locating elements inserted thereon so as to position the covering member on the adjustable tube.

In one embodiment, a securing set includes a fitting tube, and the fitting tube has a through hole formed thereon so that a connecting rod inserts into and horizontally moves in the through hole. The fitting tube is fitted on a top end of an adjustable tube and moves vertically and rotates 360 degrees leftward and rightward around the adjustable tube. The fitting tube also has at least one first clamping element disposed thereon so as to clamp the connecting rod, such that a movable position of the connecting rod is fixed by the at least one first clamping element. In addition, the fitting tube further has at least one second clamping element formed thereon so that the fitting tube clamps the adjustable tube by using the at least one second clamping element, hence a rotating position of the fitting tube is fixed.

In one embodiment, the speaker stand capable of changing the angle and the position of the speaker further contains an adjusting element inserted on the fixing member and used to lock the rotating member.

In one embodiment, the speaker stand capable of changing the angle and the position of the speaker further contains the adjusting element having a forcing bar inserted on the adjusting element so as to rotate the rotating member.

In one embodiment, the positioning plate includes two fix portions formed on two ends thereof so as to fix the speaker.

In one embodiment, the fixing member includes a first toothed portion defined on one surface thereof, and the rotating member includes a second toothed portion defined on one surface thereof so as to contact with the first toothed portion of the fixing member.

In one embodiment, the fixing member also includes a first rough layer defined on one surface thereof, and the rotating member includes a second rough layer defined on one surface thereof so as to contact with the first rough layer of the fixing member.

### BRIEF DESCRIPTION OF THE DRAWINGS

FIG. 1 is a perspective view showing the assembly of a speaker stand capable of changing an angle and a position of a speaker according to a preferred embodiment of the present invention.

FIG. 2 is a perspective view showing the exploded components of the speaker stand capable of changing the angle and the position of the speaker according to the preferred embodiment of the present invention.

FIG. 2A is a perspective view showing the assembly of a first toothed portion and a second toothed portion of the speaker stand capable of changing the angle and the position of the speaker according to the preferred embodiment of the present invention.

FIG. 3 is a perspective view showing the operation of the speaker stand capable of changing the angle and the position of the speaker according to the preferred embodiment of the present invention.

FIG. 4 is a perspective view showing the assembly of a speaker and the speaker stand according to the preferred embodiment of the present invention.

FIG. 4A is a partial enlarged diagram of FIG. 4 showing the assembly of a speaker and the speaker stand according to the preferred embodiment of the present invention.

FIG. 5 is a plan view showing the speaker being rotated upwardly and downwardly according to the preferred embodiment of the present invention.

FIG. 6 is a plan view showing the speaker being changing its horizontal distance according to the preferred embodiment of the present invention.

FIG. 7 is a plan view showing the speaker being rotated toward a leftward direction or a rightward direction according to the preferred embodiment of the present invention.

FIG. 8 is a perspective view showing the speaker being adjusted its height according to the preferred embodiment of the present invention.

FIG. 9 is a perspective view showing the assembly of a securing set of a speaker stand according to another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

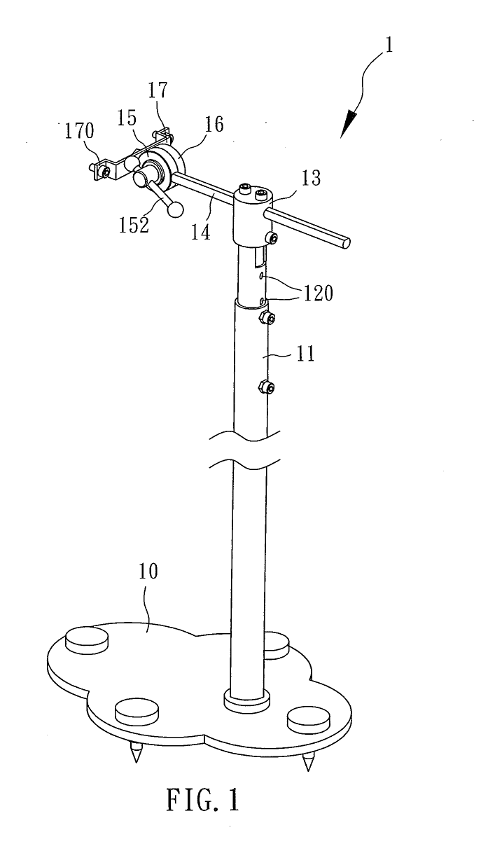

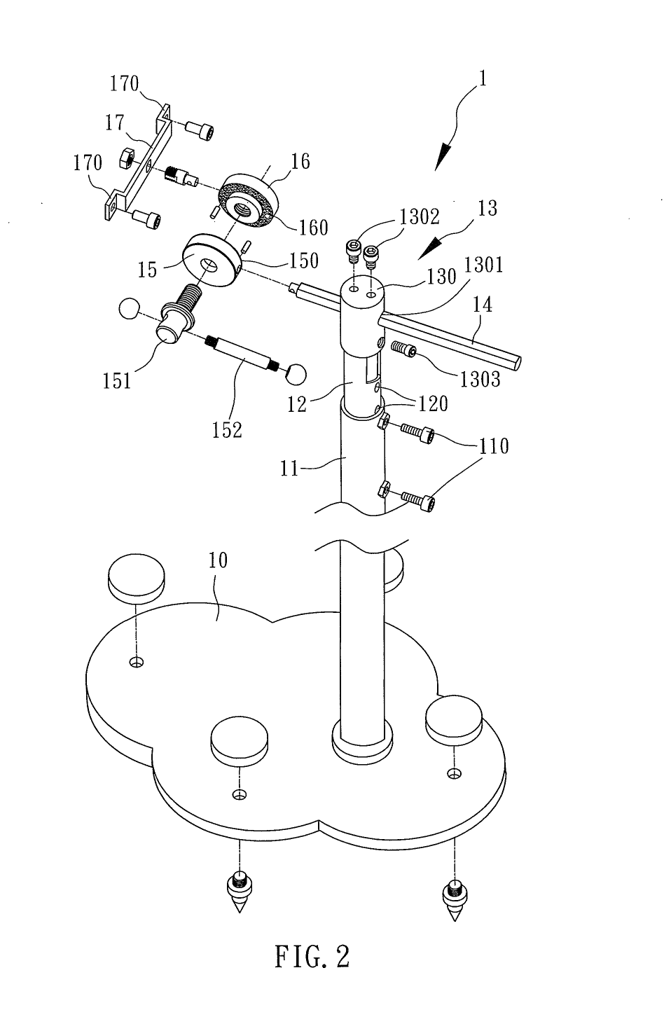

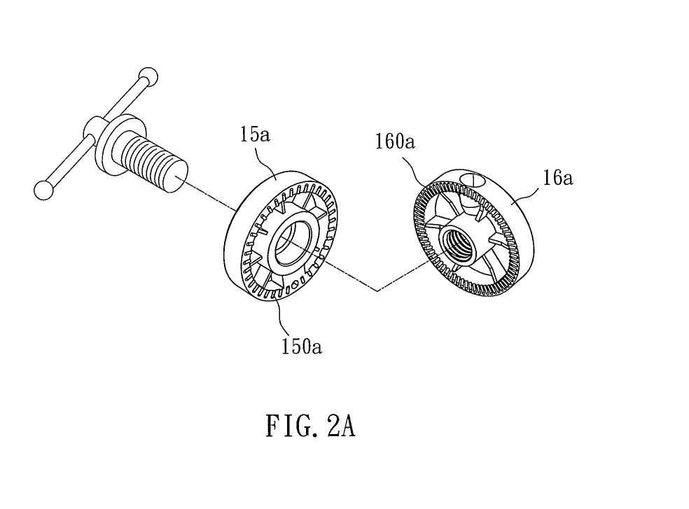

FIG. 1 is a perspective view showing the assembly of a speaker stand capable of changing an angle and a position of a speaker according to a preferred embodiment of the present invention. FIG. 2 is a perspective view showing the exploded components of the speaker stand capable of changing the angle and the position of the speaker according to the preferred embodiment of the present invention. The speaker stand 1 of the present invention comprises a base 10, an upright tube 11, an adjustable tube 12, a securing set 13, a connecting rod 14, a fixing member 15, a rotating member 16, and a positioning plate 17, wherein the base 10 includes the upright tube 11 disposed therein, the adjustable tube 12 is mounted therein and moves upwardly and downwardly in the upright tube 11. The securing set 13 is fitted on a top end of the adjustable tube 12 and is supported by the adjustable tube 12 so as to rotate 360 degrees leftward and rightward. The adjustable tube 12 are fitted into the upright tube 11, and the securing set 13 moves upwardly and downwardly by adjusting the adjustable tube 12. The connecting rod 14 is connected with the securing set 13 and moves horizontally relative to the securing set 13. The fixing member 15 is located at one end of the connecting rod 14, the rotating member 16 is axially connected with the fixing member 15, and the positioning plate 17 is secured on one side of the rotating member 16 and rotates along the rotating member 16. The adjustable tube 12 includes a plurality of pores 120 defined thereon, and the upright tube 11 includes at least one first locating element 110 for being inserted into one of the plurality of pores 120 so as to fix the adjustable tube 12.

Preferably, the securing set 13 includes a covering member 130, and the covering member 130 has a through hole 1301 formed thereon so that the connecting rod 14 inserts into and horizontally moves in the through hole 1301. The covering member 130 is fitted on the top end of the adjustable tube 12 and moves vertically and rotates 360 degrees leftward and rightward around the adjustable tube 12. The covering member 130 also has at least one second locating element 1302 disposed thereon so as to fix the connecting rod 14 on the covering member 130. In addition, the covering member 130 further has at least one third locating elements 1303 inserted thereon so as to position the covering member 130 on the adjustable tube 12.

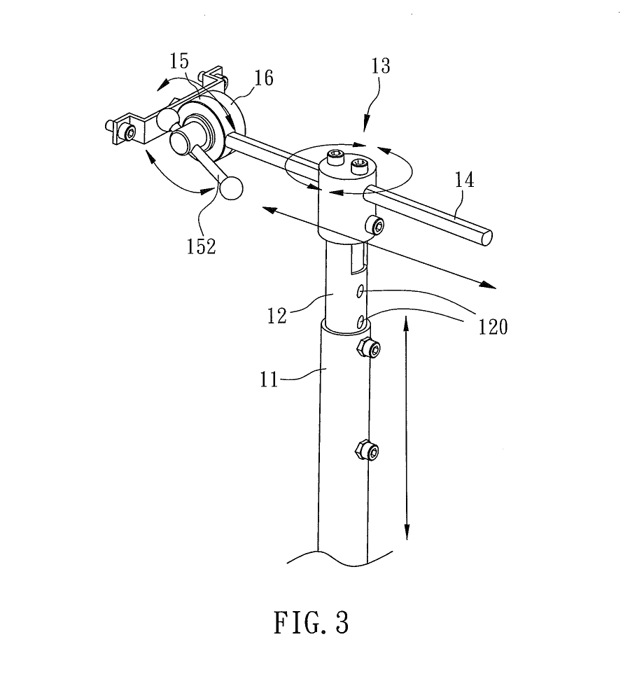

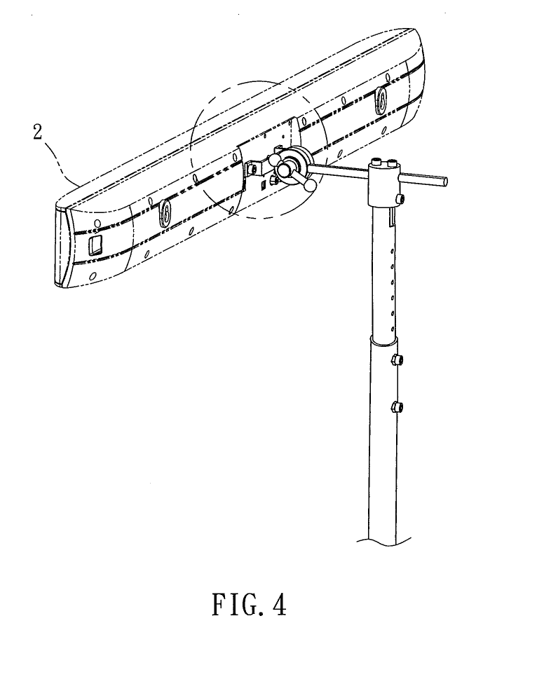

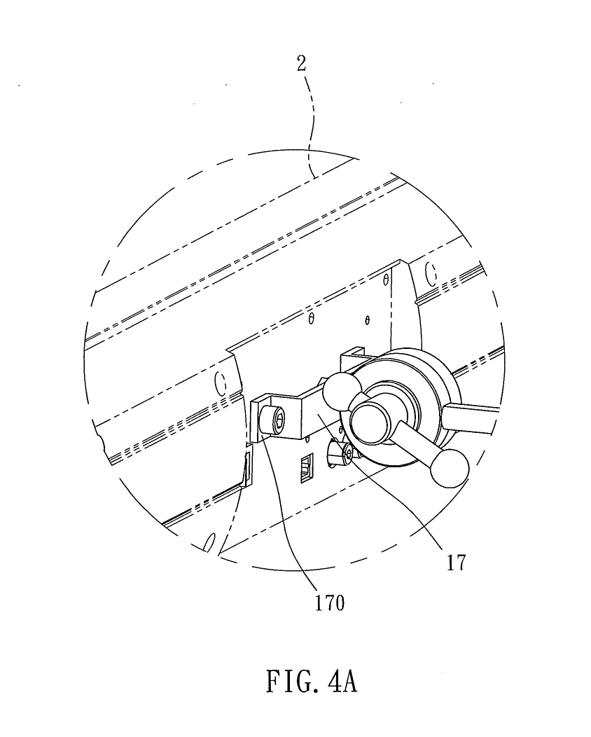

As shown in FIGS. 2 and 3, the fixing member 15 includes an adjusting element 151 inserted thereon and used to lock the rotating member 16, wherein the adjusting element 151 has a forcing bar 152 inserted thereon so as to rotate the rotating member 16, and the positioning plate 17 includes two fix portions 170 formed on two ends thereof to fix a speaker 2, wherein the fixing member 15 also includes a first rough layer 150 defined on one surface thereof, and the rotating member 16 includes a second rough layer 160 defined on one surface thereof so as to contact with the first rough layer 150 of the fixing member 15, thus increasing friction. In addition, the securing set 13 also includes at least one third locating elements 1303 mounted on a lower side thereof so as to position the securing set 13 on the adjustable tube 12 after the securing set 13 is rotated. As illustrated in FIG. 4 and FIG. 4A, the two fix portions 170 of two ends of the positioning plate 17 are applied to fix the speaker 2.

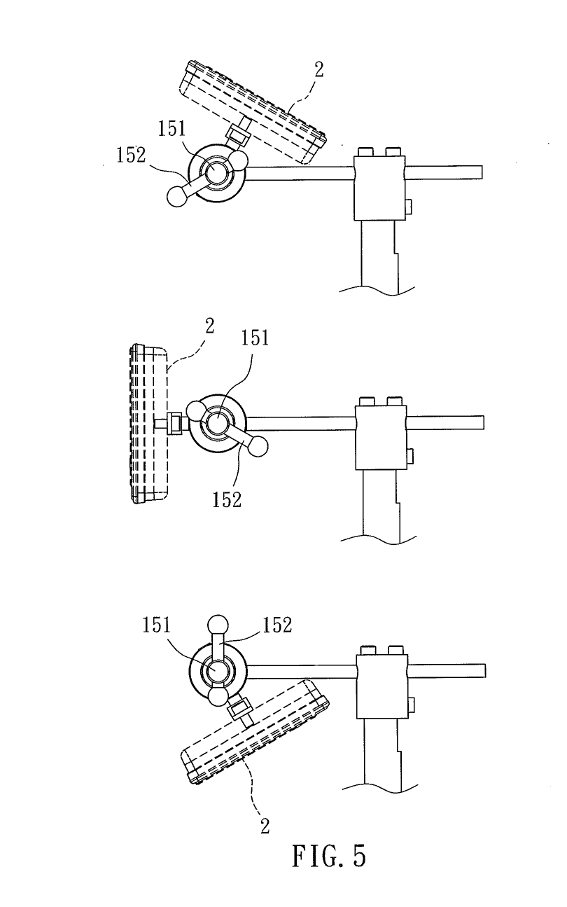

FIG. 5 is a plan view showing the speaker being rotated upwardly and downwardly. Also, as shown in FIG. 2, the adjusting element 151 is released by ways of the forcing bar 152 so that the rotating member 16 is in a free state, and then the speaker 2 is rotated and is fixed at any desired angle based on using requirement, thereafter the forcing bar 152 is used for locking the adjusting element 151. In the meantime, the first rough layer 150 of the fixing member 15 contacts with the second rough layer 160 of the rotating member 16, thus increasing friction and locking effect.

The fixing member 15 and the rotating member 16 are provided to increase the friction of the first rough layer 150 and the second rough layer 160. In addition, FIG. 2A shows a positioning structure of a fixing member 15a and a rotating member 16a of a speaker stand capable of changing an angle and a position of the speaker according to another preferred embodiment of the present invention, wherein the fixing member 15a includes a first toothed portion 150a defined on one surface thereof, and the rotating member 16a includes a second toothed portion 160a defined on one surface thereof so as to contact with the first toothed portion 150a of the fixing member 15a, and as the first toothed portion 150a is convex, the second toothed portion 160a is concave so as to match with the first toothed portion 150a, thus obtaining a locking and positioning purpose. When the speaker stand rotates in the free state, the first toothed portion 150a disengages from the second toothed portion 160a, thereby rotating the rotating member 16a to change angle. Therefore, the first toothed portion 150a and the second toothed portion 160a are used to position the fixing member 15a and the rotating member 16a.

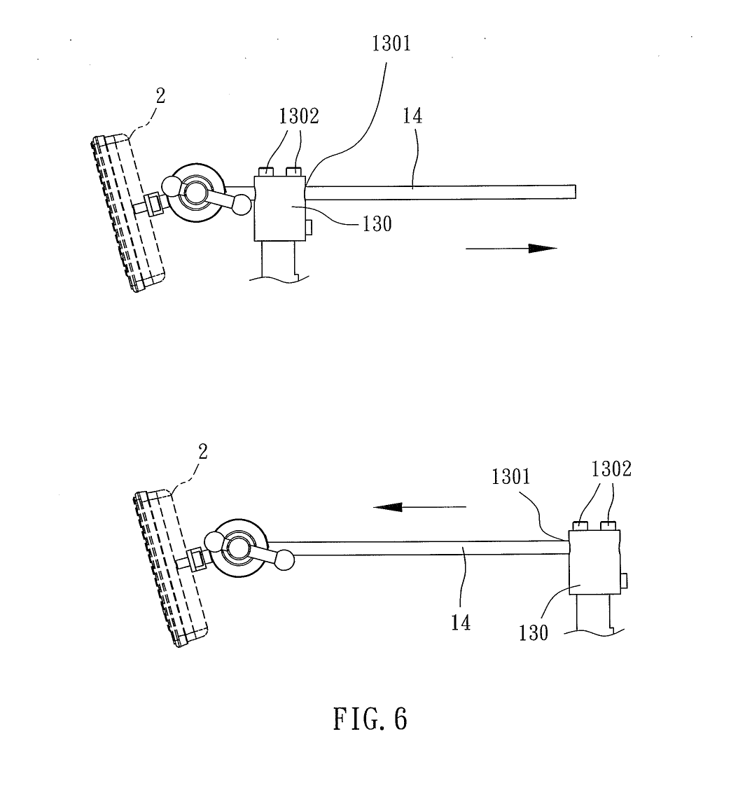

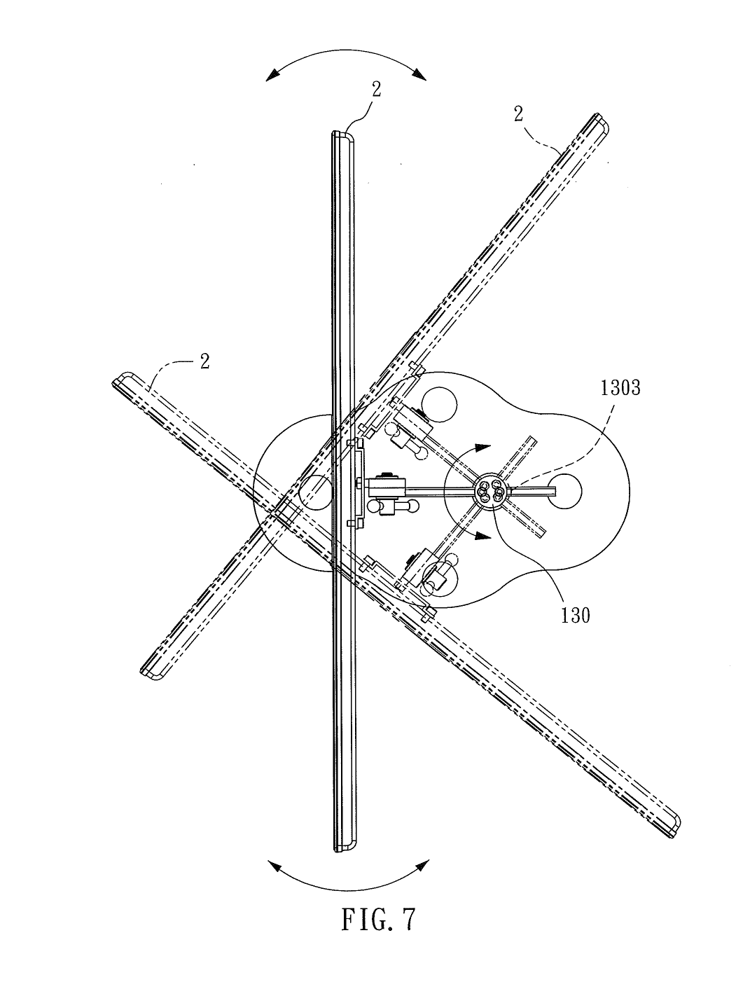

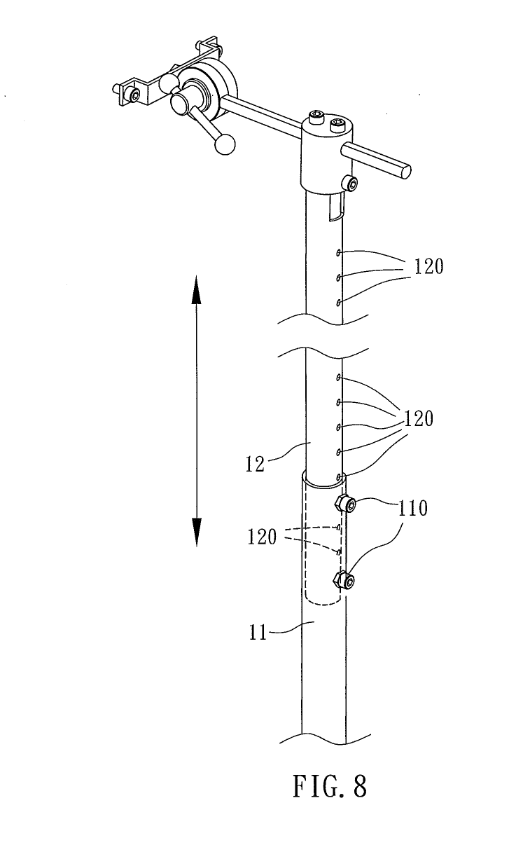

FIG. 6 is a plan view showing the speaker being changing its horizontal distance, wherein second locating elements 1302 are released from the securing set 13, and the connecting rod 14 moves in the through hole 1301 freely, such that the horizontal distance of the speaker 2 is adjusted according to the using requirement, thereafter the second locating elements 1302 are locked and biased against the connecting rod 14 securely. FIG. 7 is a plan view showing the speaker 2 being rotated toward a leftward direction or a rightward direction, wherein the third locating elements 1303 are released from the securing set 13 so as to rotate the securing set 13, such that the speaker 2 is rotated leftward or rightward and then is positioned. Thereafter, the third locating elements 1303 are locked on the adjustable tube 12, and the securing set 13 is fitted on the adjustable tube 12, thus adjusting the position of the speaker leftward or rightward. FIG. 8 is a perspective view showing the speaker being adjusted its height, wherein the first locating elements 110 are released from the adjustable tube 12 so that the adjustable tube 12 is moved upwardly and downwardly, and since the adjustable tube 12 has a plurality of orifices 120 defined thereon, so after a height of the adjustable tube 12 is adjusted, the first locating elements 110 are inserted through the plurality of orifices 120 and then touch the adjustable tube 12, the first locating elements 110 are locked so as to adjust the adjustable tube 12. Thereby, the speaker stand is capable of changing its angle and position so as to further adjust the angle of the speaker and position the position of the speaker, thus obtaining best sound field effect. Besides, the speaker stand has simple structure and is operated easily.

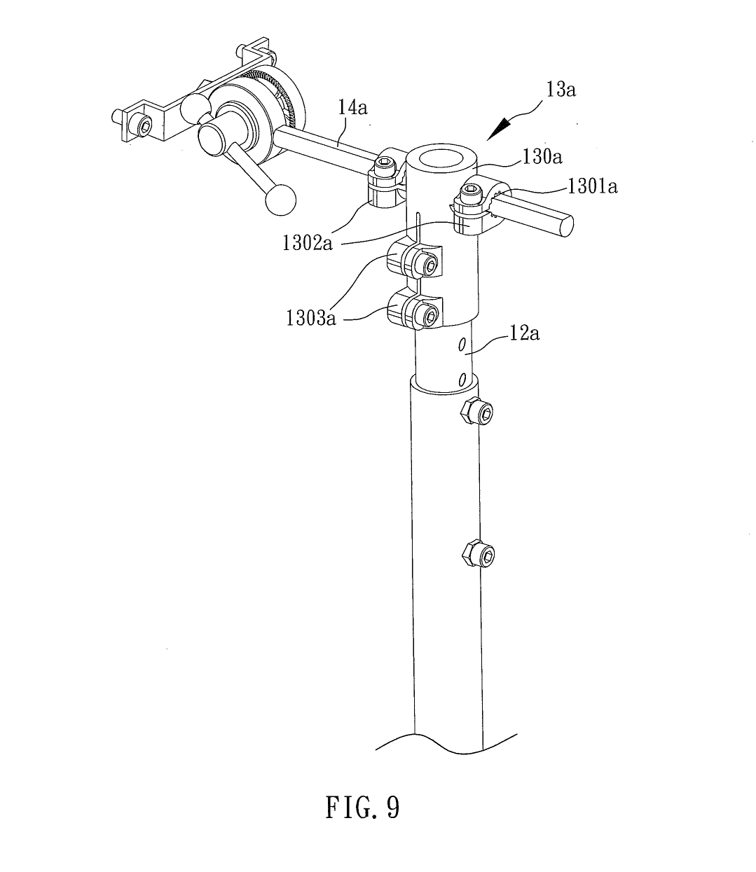

FIG. 9 is a perspective view showing the assembly of a securing set of a speaker stand according to another preferred embodiment of the present invention. A securing set 13a includes a fitting tube 130a, and the fitting tube 130a has a through hole 1301a formed thereon so that a connecting rod 14a inserts into and horizontally moves in the through hole 1301a. The fitting tube 130a is fitted on a top end of an adjustable tube 12a and moves vertically and rotates 360 degrees leftward and rightward around the adjustable tube 12a. The fitting tube 130a also has at least one first clamping element 1302a disposed thereon so as to clamp the connecting rod 14a, such that a movable position of the connecting rod 14a is fixed by the at least one first clamping element 1302a.

In addition, the fitting tube 130a further has at least one second clamping element 1303a formed thereon so that the fitting tube 130a clamps the adjustable tube 12a by using the second clamping element 1303a, hence a rotating position of the fitting tube 130a is fixed. The first clamping element 1302a and the second clamping element 1303a allow clamping and unclamping the connecting rod 14a and the adjustable tube 12a. Due to the other structure of the speaker stand in this another embodiment is the same as that of the preferred embodiment, further remarks are omitted.

While we have shown and described various embodiments in accordance with the present invention, it is clear to those skilled in the art that further embodiments may be made without departing from the scope of the present invention.

What is claimed is:

1. A speaker stand capable of changing an angle and a position of a speaker being used to support the speaker and comprising:
a base including an upright tube disposed therein;
an adjustable tube mounted in and moving upwardly and downwardly in the base;
a securing set, fitted on a top end of the adjustable tube, moving vertically and rotating 360 degrees leftward and rightward relative to the upright tube by ways of the adjustable tube;
a connecting rod connected with the securing set and moving horizontally relative to the securing set, and a fixing member being located at one end of the connecting rod; and
a rotating member axially connected with and rotating relative to the fixing member, a positioning plate being secured on one side of the rotating member and rotating along the rotating member.

2. The speaker stand capable of changing the angle and the position of the speaker as claimed in claim 1, wherein the adjustable tube includes a plurality of pores defined thereon.

3. The speaker stand capable of changing the angle and the position of the speaker as claimed in claim 2, wherein the upright tube includes at least one first locating element for inserting into one of the plurality of pores so as to fix the adjustable tube.

4. The speaker stand capable of changing the angle and the position of the speaker as claimed in claim 3, wherein the securing set includes:
a covering member having a through hole formed thereon so that the connecting rod inserts into and horizontally moves in the through hole, the covering member being fitted on the top end of the adjustable tube and moving vertically and rotating 360 degrees leftward and rightward around the adjustable tube;
the covering member also having at least one second locating element disposed thereon so as to fix the connecting rod on the covering member; and
the covering member further having at least one third locating elements inserted thereon so as to position the covering member on the adjustable tube.

5. The speaker stand capable of changing the angle and the position of the speaker as claimed in claim 1, wherein the securing set includes:
a fitting tube having a through hole formed thereon so that a connecting rod inserts into and horizontally moves in the through hole, the fitting tube being fitted on the top end of an adjustable tube and moving vertically and rotating 360 degrees leftward and rightward around the adjustable tube;
the fitting tube also having at least one first clamping element disposed thereon so as to clamp the connecting rod, such that a movable position of the connecting rod is fixed by the at least one first clamping element; and
the fitting tube further having at least one second clamping element formed thereon so that the fitting tube clamps the adjustable tube by using the at least one second clamping element, hence a rotating position of the fitting tube is fixed.

6. The speaker stand capable of changing the angle and the position of the speaker as claimed in claim 1 further comprising an adjusting element inserted on the fixing member and used to lock the rotating member.

7. The speaker stand capable of changing the angle and the position of the speaker as claimed in claim 6, wherein the adjusting element has a forcing bar inserted thereon so as to rotate the rotating member.

8. The speaker stand capable of changing the angle and the position of the speaker as claimed in claim 1, wherein the positioning plate includes two fix portions formed on two ends thereof so as to fix the speaker.

9. The speaker stand capable of changing the angle and the position of the speaker as claimed in claim 1, wherein the fixing member also includes a first rough layer defined on one surface thereof, and the rotating member includes a second rough layer defined on one surface thereof so as to contact with the first rough layer of the fixing member.

10. The speaker stand capable of changing the angle and the position of the speaker as claimed in claim 1, wherein the fixing member includes a first toothed portion defined on one surface thereof, and the rotating member includes a second toothed portion defined on one surface thereof so as to contact with the first toothed portion of the fixing member.
